(19) United States
(12) Patent Application Publication
(10) Pub. No.: US 2004/0007440 A1
(43) Pub. Date: Jan. 15, 2004

(54) Chassis/body marriage machine with helical push actuator

(75) Inventor: Paul G. Doan, Macomb, MI (US)

Correspondence Address: JAMES D. STEVENS, REISING, ETHINGTON, BARNES, KISSELLE, ET AL, P.O. BOX 4390, TROY, MI, 48099, US

(73) Assignee: Fori Automation, Inc., Shelby Township, MI

(21) Appl. No.: 10/452,371

(22) Filed: Jun. 2, 2003

Related U.S. Application Data
(60) Provisional application No. 60/384,474, filed on May 31, 2002.

(51) Int. Cl. B65G 29/00

(52) U.S. Cl. 198/468.8

(57) ABSTRACT

A machine for supporting and lifting an automotive chassis module into position for assembly with an automobile body includes a mobile vehicle having at least one fixture arranged above the vehicle for receiving and supporting the chassis module and a guided lift mechanism for moving the fixture vertically between lowered and raised positions. The lift mechanism includes a helical push actuator having a drive motor and at least one band that can be advanced and retracted in a vertical helix with an end of the band being coupled to the fixture to move the fixture between the lowered and raised positions by helical advancement of the band under control of the motor. The lift mechanism includes spaced support members that each extend between the fixture and the vehicle to guide the fixture in the vertical direction and restrain the fixture from moving horizontally.

### CROSS-REFERENCE TO RELATED APPLICATION

This application claims the priority of U.S. Provisional Application No. 60/384,474, filed May 31, 2002, the entire contents of which are hereby incorporated by reference.

### TECHNICAL FIELD

This invention relates generally to lift machines used in the automotive vehicle manufacturing industry for marrying chassis modules with vehicle bodies and, more particularly, for lifting the chassis modules into place underneath suspended vehicle bodies for subsequent fastening of the chassis modules to the vehicle bodies.

### BACKGROUND OF THE INVENTION

In the manufacturing of automotive vehicles, it is customary to preassemble components of the chassis of the vehicle before marrying them with the vehicle body. The bringing together of the chassis and body takes place on a continuously moving conveyor line. The body is typically conveyed overhead by a conveyor, and the chassis components to be married to the body are supported by a fixture of a moving lift machine that operates to move the chassis components into position beneath the moving body while lifting the chassis components into position for assembly with the body.

Many of the lift machines in present use employ a pneumatically powered hydraulic lift mechanism to raise and lower the fixture or fixtures that carry the chassis components. Some machines have a single fixture, whereas others are equipped with two such fixtures provided at opposite ends of the lift machine. Each fixture has its own hydraulic system and the two are often synchronized to operate in unison.

The hydraulic systems each include a fluid cylinder that is mounted on the machine and secured to its associated fixture. A pair of multi-stage telescoping vertical guides are provided on opposite sides of each cylinder and guide the fixture vertically. A longitudinally extending cabinet projects above a base of the machine in the space between the fixtures and houses various components associated with the control and operation of the hydraulic/pneumatic systems. Among the components accommodated within the cabinet is a reservoir containing hydraulic fluid to be supplied to the cylinders, and an onboard pneumatic pump system that drives the hydraulics. Then pump system has onboard rechargeable air tanks also housed in the cabinet that hold a supply of pressurized air for operating the pump. The pump in turn controls the flow of hydraulic fluid to and from the cylinders in order to raise and lower the platforms.

While the traditional hydraulic/pneumatic lift mechanism of such machines performs satisfactorily in raising and lowering the platforms, it has several inherent disadvantages which add cost and complexity to the operation, many of which are unique to the art of chassis component lift machines.

The hydraulic systems have various seals, fittings and other components that are prone to frequent leakage and failure and require the constant attention of skilled workmen to maintain them in working order. It also requires that a fairly large capacity hydraulic fluid reservoir be carried on board the machine to supply fluid to the cylinders, adding to the size, cost and weight of the machines.

The rechargeable pneumatic pump system presents its own set of problems. The pump relies for its power on the supply of pressurized air from the onboard tanks. When the air in the tanks is exhausted, the pump and thus the hydraulics are no longer operational. A spent machine must be routed out of the normal assembly loop to a specialized recharge station where the tanks are refilled with pressurized air. During this time, another machine must be introduced in its place to support the continuous assembly operation. Since a full charge typically provides at most three lift cycles before requiring recharging, a number of extra machines must be kept on hand to support the assembly operation, adding further to the cost of supporting the operation. The specially equipped charging stations also add to the cost of the operation and can occupy valuable floor space of a facility.

Another objection inherent with the existing hydraulic/pneumatic lift system is that the elevated cabinet needs to be fairly tall in order to house the various components of the hydraulic/pneumatic system. The presence of the elevated cabinet can obstruct full access to the components supported on the fixtures to those assisting in the assembly operation, and particularly their step-through passage across the machine, making it less convenient to reach certain areas.

One solution proposed to overcome problems inherent in hydraulic-based systems is the use of a rigid chain used to provide vertical lift in place of the hydraulic lift mechanism. Such a system is the subject of U.S. Pat. No. 6,109,424, which is assigned to the assignee of this invention.

A chassis lift apparatus constructed in accordance with the present invention provides yet another alternative to conventional hydraulic/pneumatic chassis lift machines.

### SUMMARY OF THE INVENTION

In accordance with one aspect of the present invention, there is provided an apparatus for lifting and supporting an automotive chassis module in position to be assembled with an automotive body along a moving assembly line. The apparatus comprises a mobile vehicle, at least one fixture arranged above the vehicle for receiving and supporting the chassis module, and a guided lift mechanism for moving the fixture vertically between a lowered position and a raised position. The lift mechanism includes a push actuator having a drive motor and at least one band that can be advanced and retracted in a vertical helix with an end of the band being coupled to the fixture to move it between the lowered and raised positions by helical advancement of the band under control of the motor. The lift mechanism further includes at least one support member extending between the fixture and vehicle operative to guide the fixture in the vertical direction and restrain the fixture from moving horizontally.

In accordance with another aspect of the present invention, there is provided a method of supporting and lifting an automotive chassis module for assembly with an automotive body. The method comprising the steps of:

loading the chassis module onto a fixture supported at a lowered position and coupled to a push actuator mounted on a mobile vehicle;

operating the push actuator to raise the fixture vertically by upward advancement of at least one helical band; and

providing at least one support member between the fixture and the vehicle to guide the fixture during its vertical movement while restraining the fixture from horizontal movement.

The push actuator enables construction of a chassis/body marriage lift machine that can maintain a very low profile when retracted while advancing the fixture to a total height of many times its retracted height. Other features and advantages of the present invention will become apparent after reading the following description of the illustrated embodiment.

### BRIEF DESCRIPTION OF THE DRAWINGS

A preferred exemplary embodiment of the invention will hereinafter be described in conjunction with the appended drawings, wherein like designations denote like elements, and wherein:

FIG. 1 is a diagrammatic elevational view depicting an embodiment of the chassis lift machine of the present invention as it would be utilized as part of an automobile manufacturing production line;

FIG. 2 is a front view showing the lift mechanism used in the chassis lift machine of FIG. 1;

FIG. 3 is a plan view of the lift mechanism of FIG. 2;

FIG. 4 is, a side view of the helical lift mechanism used in the embodiment of FIG. 1;

FIG. 5 is a plan view of the helical lift mechanism of FIG. 4;

FIG. 6 is a side sectional view of the lift mechanism of FIG. 2; and

FIG. 7 is a rear view of the lift mechanism of FIG. 2.

### DETAILED DESCRIPTION OF THE PREFERRED EMBODIMENT

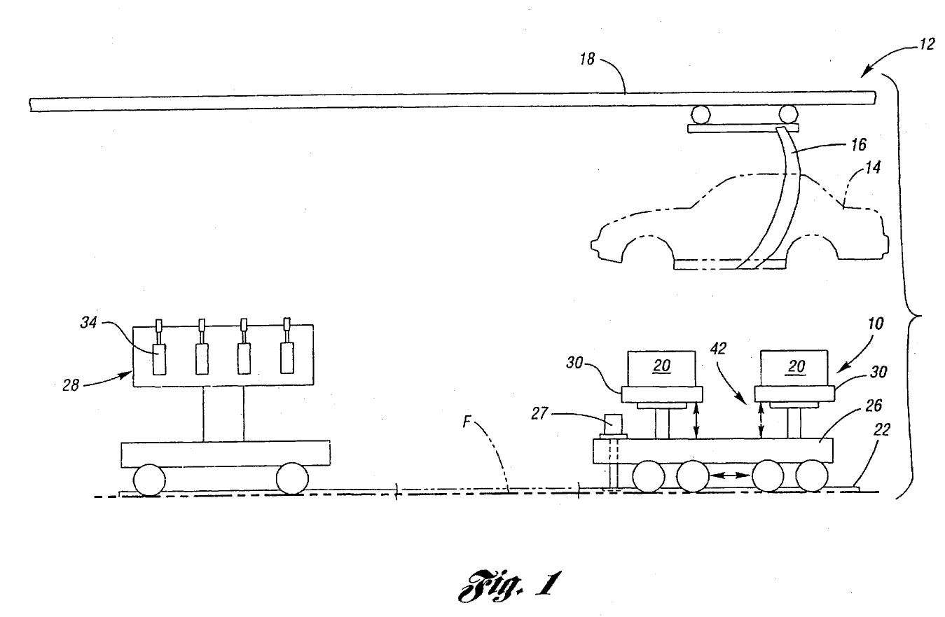

As shown in FIG. 1, a chassis/body marriage lift machine (or chassis lift vehicle or apparatus) of the present invention is designated generally at 10 and is shown as it would be used at a chassis/body marriage and assembly station 12 of an automotive production line. Automotive vehicle bodies, such as that shown at 14, are brought into station 12 one at a time by an overhead clamshell conveyor 16 that is supported by and moves around an endless overhead rail 18. Automotive chassis modules 20 are also brought into station 12 via an overhead conveyor and then are placed onto lift machine 10 for subsequent assembly into vehicle body 14.

To provide a continuously operating production line, the lifting and assembly of the chassis module 20 into vehicle body 14 is carried out while the vehicle body 14 moves along the clamshell conveyor 16. Thus the lift machine 10 runs along a floor track 22 (or is self-guided) underneath the conveyor 16 while chassis module 20 is lifted and fastened into the vehicle body 14. Movement of lift machine 10 along track 22 and the required synchronization of lift machine 10 with conveyor 16 are well known to those skilled in the art and will therefore not be elaborated upon.

The machine 10 includes a wheeled vehicle 26 that serves as the base or framework of the machine 10 on which other components of the machine are supported. There are generally three types or classes of vehicles 26 that may be utilized in conjunction with the lift mechanism of the invention to be described. They include those that are self-propelled but guided by a floor track such as that shown at 22, a so-called tow-veyor type vehicle which is towed by a floor cable or the like along a floor track 22, or a self-powered, self-guided type vehicle, known generally as an automatic guided vehicle or AGV, which is self-propelled and programmable to be self-guided without the assistance of a floor track along a preset path. Of course, other vehicle types could be used and are contemplated as equivalent provided they are suitable for the intended purpose of marrying chassis components to automotive bodies.

FIG. 1 illustrates a self-powered vehicle 26 having an on-board drive motor 27 that drives the vehicle 26 along the guide track 22 in conventional manner. The use of chassis lift machine in assembly line production is known, as exemplified in U.S. Pat. No. 6,109,424, the entire contents of which are hereby incorporated by reference.

The fastening of chassis module 20 to vehicle body 14 can be carried out either manually or automatically. In the illustrated embodiment shown in FIG. 1, fastening is carried out automatically and in a conventional manner using a mobile screw station 28. Screw station 28 moves synchronously with lift machine 10 and vehicle body 14, during which time chassis module 20 is secured to vehicle body 14 using fasteners (not shown). Automatic fastening is accomplished using a pallet 30 that is attached to lift machine 10 and that is used to hold and properly locate chassis module 20 for assembly into vehicle body 14. Pallet 30 can be used to hold each of the required fasteners 32 at the proper location in preparation for fastening of the chassis module to the vehicle body.

Pallet 30 also includes nut drivers (not shown) for each of the fasteners.

Screw station 28 includes motorized drives 34, each of which mates with a corresponding nut driver in pallet 30 to provide automated tightening of the fasteners. As screw station 28 moves along track 22 with lift machine 10, it extends its motorized drives 34 upwards until they engage their associated nut drivers. The fasteners can then be automatically tightened into vehicle body 14.

Screw station 28 must fasten chassis module 20 to vehicle body 14 while the chassis module is being held in an upper position against the underside of the vehicle body. Thus, lift machine 10 must be able to hold the chassis module in the upper position without blocking access to any of the fastening points. In most vehicle designs, there is an approximately six inch wide longitudinal strip along the length of the vehicle in which no fasteners 32 are needed for fastening of the chassis module to the vehicle body. This strip defines an interference-free region 36 that extends lengthwise along the longitudinal axis of the lift machine and widthwise between opposed fastening regions 38, 40.

To avoid interference with screw station 28, lift machine 10 includes at least one and often two guided lift mechanisms 42 mounted on the vehicle 26 at opposite front and rear ends there. The lift mechanisms are designed to extend only within this interference-free region during the raising and lowering of chassis module 20.

Although the lift machine depicted in FIG. 1 is shown front and rear guided lift mechanisms 42, it will be understood that only a front or rear lift mechanism may be required, depending upon the application. In this regard, it should be noted that chassis module 20 can be the full vehicle chassis module, including the engine, transmission, drive train, and suspension requiring both the front and rear lift mechanisms 42, or can be a portion of the full vehicle chassis module, such as a front or rear chassis module, in which case only one of the front and rear lift mechanisms 42 may be required.

In the description that follows, reference will be made to a single lift mechanism 42. However, for those applications utilizing both front and rear lift mechanisms, the other lift mechanism could be and preferably is identical to the one described below and the two lift mechanisms could be run synchronously to raise a full chassis module into place. For this purpose, the two lift motors used to raise the chassis module could include position encoders or other position sensors to permit the synchronous operation.

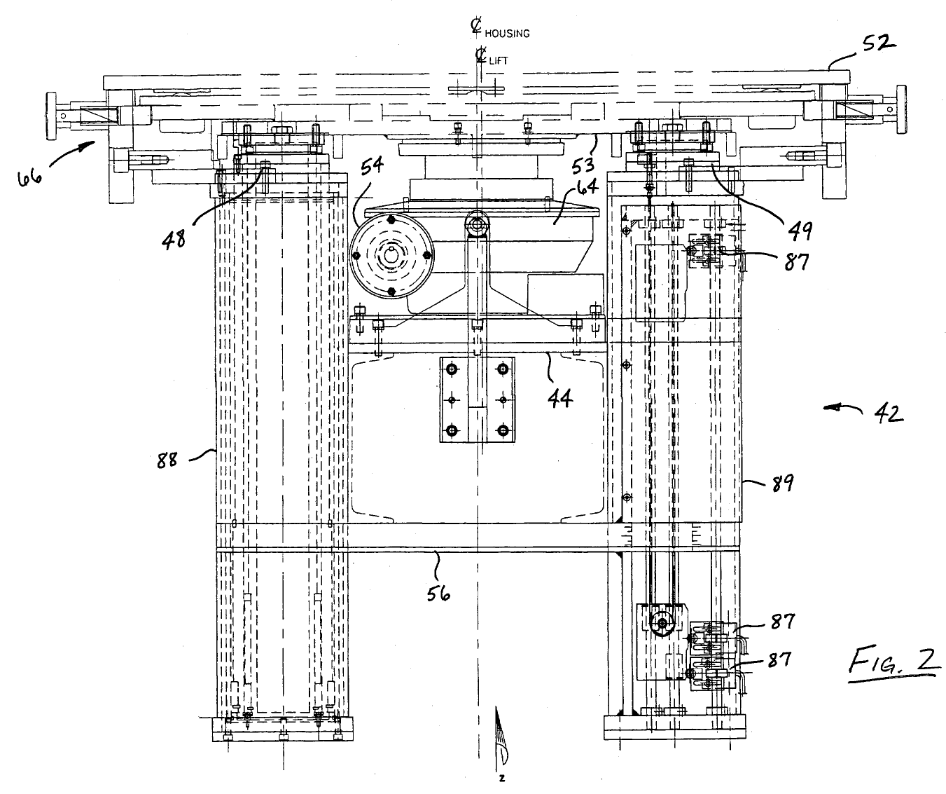

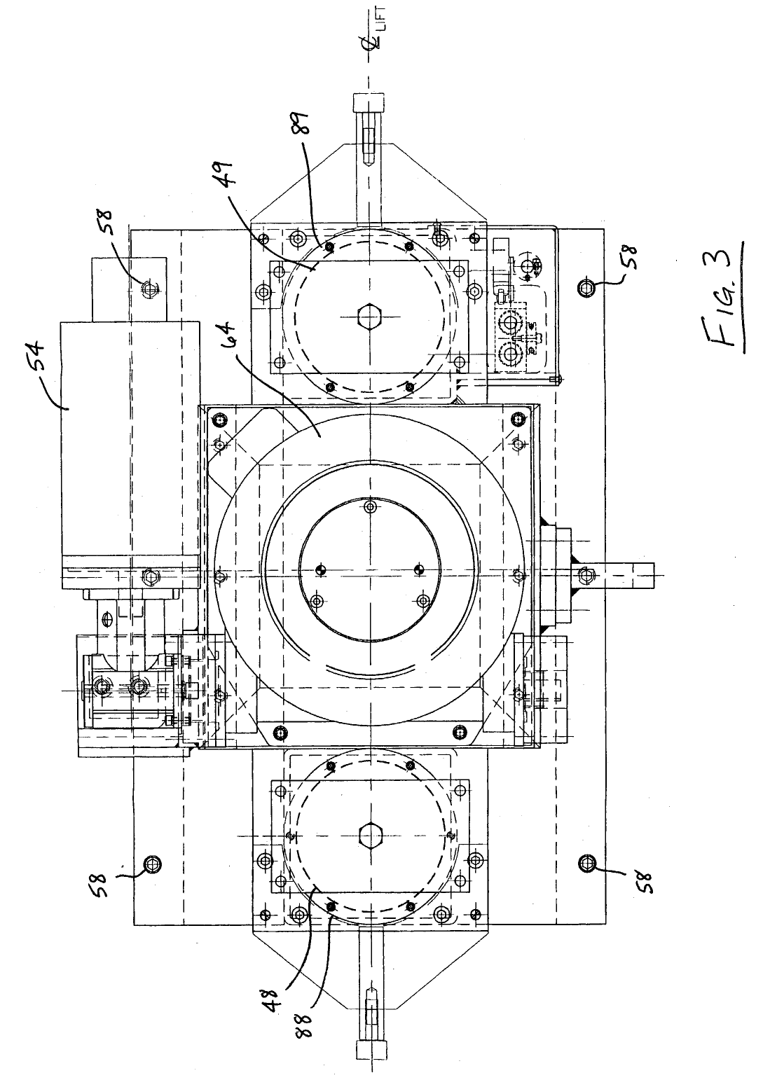

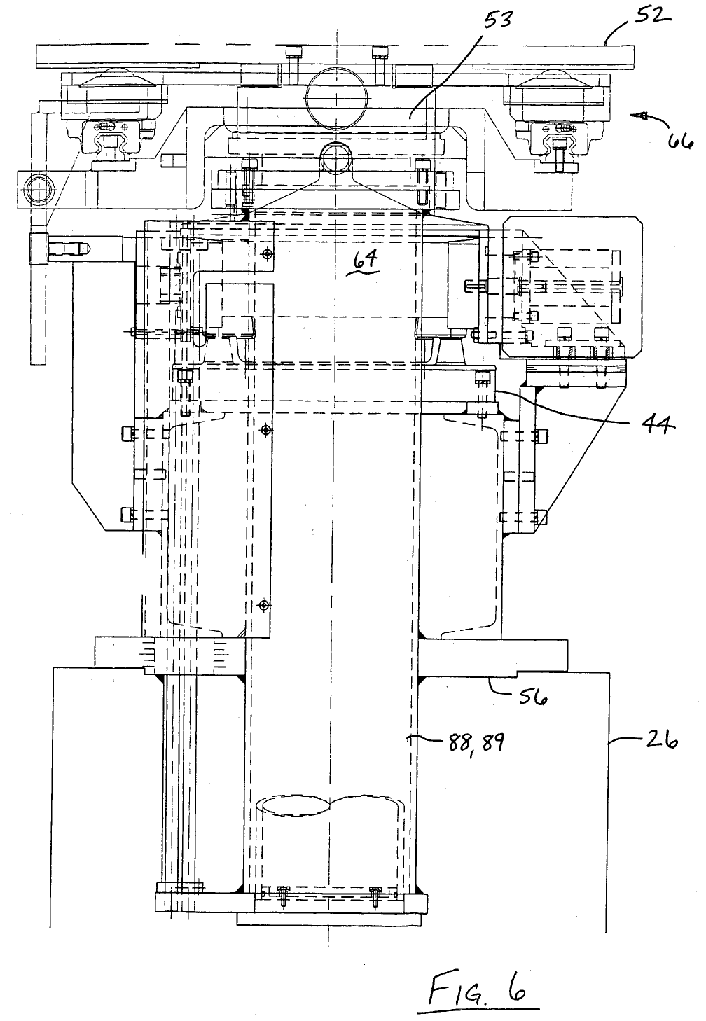

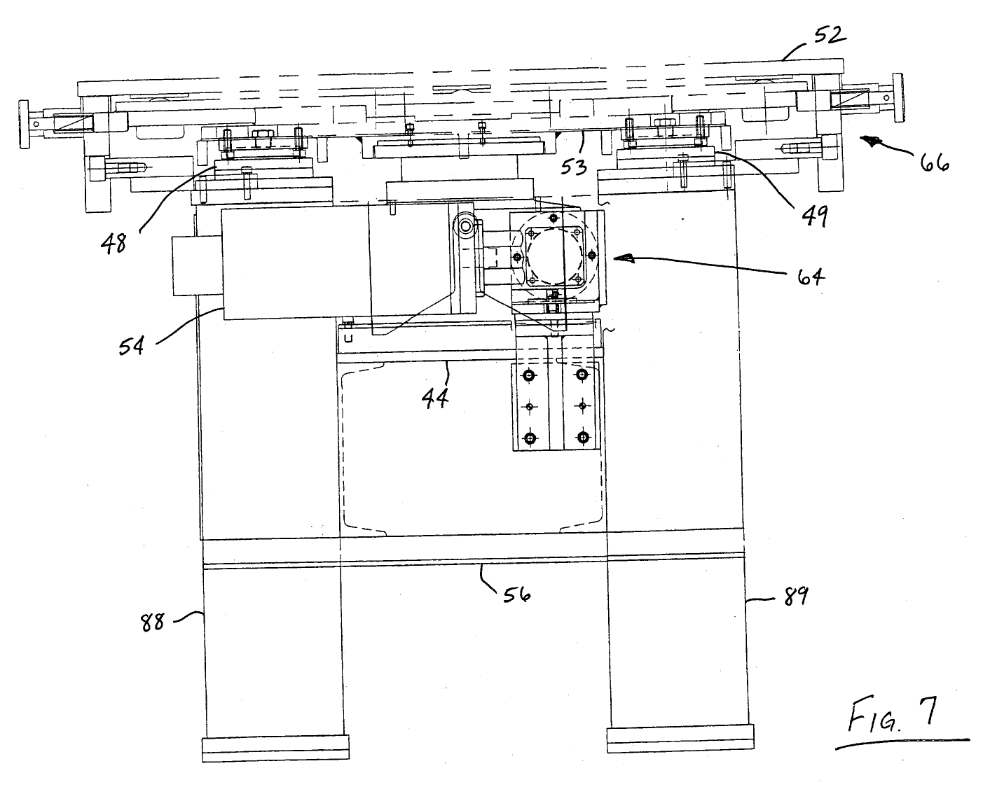

As shown in FIGS. 2, 3, 6 and 7, lift mechanism 42 is constructed preferably as a separate, self-contained unit apart from the vehicle 26 and includes push actuator base 44, support members 48 and 49, fixture 52, an upper base 53, and a push actuator 64. The motor assembly 54 is rigidly mounted on the push actuator. Also included is a mounting plate 56 that is mounted on the vehicle 26, which is spaced a predetermined fixed distance above the shop floor 22. It is preferred that the lift mechanism 42 be mounted releasably on vehicle 26, so that the mechanism can be attached and detached from the vehicle 26 when needed for maintenance or replacement. Accordingly, bolts 58 or other suitable fastening means may be employed to secure the mounting plate 56 to the vehicle 26. Alternatively, the mounting plate 56 could be permanently affixed to the vehicle 26 such as by weldments or the like.

Support members 48, 49 operate to guide the upper base 53 in the vertical direction while restraining the upper base 53, and thus the fixture 52, against horizontal movement relative to the base 44 of the lift mechanism 42. Such support of the fixture 52 helps maintain the stability of the lift mechanism 42 and prevents undue lateral forces from being exerted on the lift mechanism 42. Support members 48, 49 preferably comprise vertical telescoping guides or multistage guides, as illustrated, of the type constructed from telescoping cylindrical column members that extend freely in the vertical longitudinal direction with the movement of the upper base 53, but restrain the upper base 53 against horizontal movement. The support members are housed in appropriately sized hollow structures 88, 89 that allow for retention and storage of the support members 48, 49. There may be included appropriate positional control mechanisms such as the switching mechanism 87 shown in FIG. 2, to control the position of the support members 48, 49. In addition to or in lieu of the telescoping guides, any other suitable type of support member can be used that guides the fixture 52 vertically during the lift while restricting it from horizontal movement; for example, a scissors linkage can be used.

The fixture 52 is attached to upper base 53 by a conventional floating plate mechanism 66 that is slidably supported on the horizontally restrained upper base plate 53. The floating plate mechanism 66 is movable horizontally relative to the upper base plate 53 both longitudinally and laterally of the vehicle 26 to enable corresponding adjustment in the position of the fixture 52 and thus the pallet 30 and its chassis module 20.

The push actuator 64 can be identical to that described in U.S. Pat. No. 4,875,660, the entire contents of which are hereby incorporated by reference.

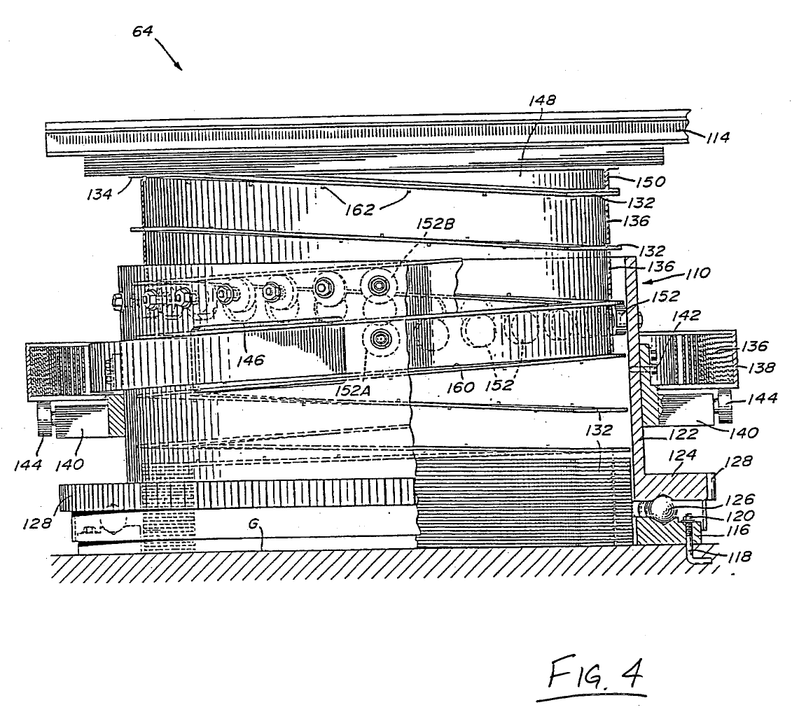

Alternatively, the modified push actuator disclosed in U.S. Pat. No. 6,547,216 can be used for push actuator 64, and the entire contents of that patent are also hereby incorporated by reference. Push actuator 64 can be, for example, a model HD9 Spiralift™, available from Paco Corp. of Quebec, Canada. Referring now to FIG. 4, salient features of the push actuator 64 will now be described, and reference is made to the aforementioned U.S. Pat. Nos. 4,875,660 and 6,547,216 for further details concerning the construction and use of various implementations of push actuator 64.

As shown, the push actuator 64 has an annular base 116 anchored, by means of L-shaped ground anchors 118 and nuts 120, or any other suitable anchoring means.

A rotor 122, in the form of a cylindrical body with a lower radially-outwardly-extending flange 124, is rotatable on the base 116 by means of roller bearings 126 engaging annular V-shaped grooves made in the base 116 and lower flange 124. Thus, the rotor 122 is rotatable about the central axis of the base 116 and rotor 122. The peripheral edge of the lower flange 124 forms gear teeth 128 all around, in meshing engagement with a driving gear 130 driven in rotation in both directions by a suitable motor 54.

A first continuous annular band 132, which will hereinafter be called the horizontal band for the particular application shown, is wound in an helix and is of such an external diameter as to fit within the rotor 122 and the base 116. The turns of this horizontal annular band can be successively lifted to provide a space therebetween. The lower end of the horizontal band 132 rests on the floor or ground G, while its upper leading end 134 is secured underneath the platform 114.

A second band 136, hereinafter called the vertical band for the particular application described, is wound in spiral form, the band being continuous, and when in stacked condition, located within an annular storage box 138, disposed on the outside of rotor 122 and rotatably supported with respect to the rotor by means of three equally-angularly spaced L-shaped brackets 140 fixed to the outside of rotor 122 by bolts 142 and provided at their outer end with an idle roller 144 rotatably supporting the storage box 138.

As shown in FIG. 4, the coil formed by vertical band 136 has a minimum diameter which is greater than the external diameter of the horizontal band 132, so as to clear the horizontal band when the latter is fully stacked, or when it is being extended. The radially outer end of the vertical band 136 need not be secured to the storage box 138. The radially inner leading end of the vertical band 136 extends through a rectangular opening 146 of rotor 122, inward of the rotor 122, and is tapered widthwise, to be secured to the underside of the platform 140 by suitable means, such as a cross-sectionally I-shaped member 150. Leading end 148 fits between the radially inner flanges of member 110, such that the member 110 is similar to longitudinally tapered leading end 148, the member 110 being directly secured underneath the platform 114. Therefore, the platform is maintained in level condition despite the fact that the vertical band 136 extends upwardly along a helix.

The rotor 122 is provided along its internal surface with a series of equally-spaced idle rollers 152, each mounted on a horizontal shaft 154, secured to the rotor by means of a nut 156. The idle rollers 152 are generally equally spaced for a full circle around the inside of the rotor 122 and arranged in a helix in accordance with the desired pitch of the assembly of the horizontal band 132 and vertical band 136. As shown in FIG. 4, the leading roller 152A is longitudinally aligned with the elongated opening 146, itself inclined in accordance with the above-noted pitch. The trailing roller 152B is vertically above and spaced from the leading roller 152A.

It will be understood that when the rotor 122 is rotated in a direction to elevate platform 114, the idle rollers 152 will roll under the radially outer margin of the turns of the horizontal band 132, so as to space the same from the underlying adjacent turn. At the same time, the vertical band 136 enters opening 146 and is guided radially inwardly by the inner flat faces of the rollers 152 to be inserted between two adjacent turns of the horizontal band 132. As the horizontal band 132 is being elevated by rotation of the rotor 122, and consequently of the rollers 152, along an helix concentric with the central axis of the rotor 122, the vertical band 136 is gradually inserted between the adjacent turns of the horizontal band 132, so as to gradually build up a tube or column. Insertion of the vertical band 136 is facilitated, due to the weight of the horizontal band 132 at the point of insertion, which horizontal band 132 form a gap 160.

Location structure is included to properly locate the vertical band 136 between adjacent turns of the horizontal band 132. The location structure includes a plurality of studs 162 press-fitted within various series of equally-spaced corresponding through-bores 164 made through the horizontal band 132. The through-bores 164 are preferably positioned at an equal distance from the outer peripheral edge of the horizontal band 132. A portion of the studs 162 are upwardly directed, while others are downwardly directed. This upward and downward positioning of the studs 162 locates both the top and bottom edges of the vertical band 136.

A portion of the through-bores 164 are left without any studs 162, so as to receive the studs 162 of the next adjacent turn of the horizontal band 132 when in a retracted position. The protruding portion of the studs 162 are preferably sized such that they are not longer than the thickness of the horizontal band 132.

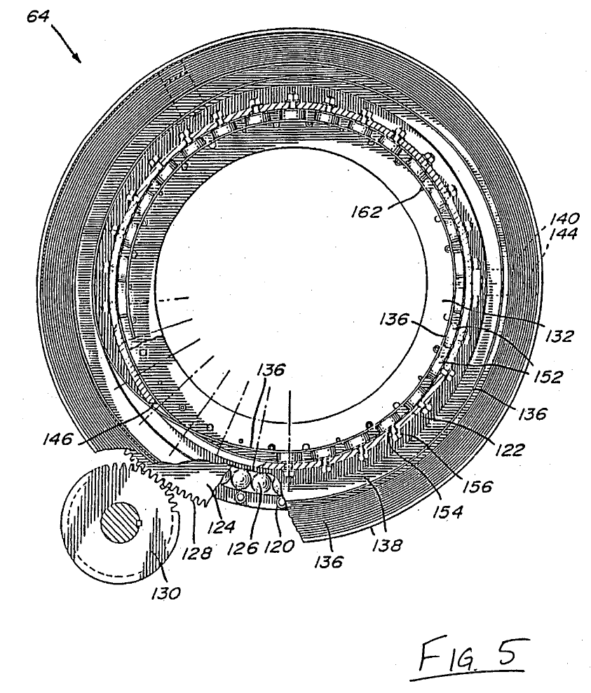

In this manner, a flat stacking of the horizontal band 132 is obtained for storage in a minimum of height. As shown in FIG. 5, the assembly of two adjacent turns of the horizontal band 132, with a turn of the vertical band 136 inserted therebetween, forms a substantially I-shaped cross-section. The resulting assembly is very strong and can support a very large load, and yet it is very stable transversely of the central axis. Depending on the length of the two bands 132 and 136, the push actuator 64 of the invention can have a very long stroke compared to its length when the two bands are in retracted position.

Preferably, the vertical band 136 is pre-rolled to possess when unstressed, a radius of curvature about equal to that of the assembled tube. This facilitates proper insertion of the vertical band 136 between the turns of the horizontal band 132.

Magazine or box 138 is free to rotate about the tube axis to permit vertical band 136 insertion and removal despite the resulting variation of the internal diameter of the coil formed by the vertical band 136 in the box 138.

In constructing and operating a chassis module lift machine 10, at least one and in many applications two mechanical push lift devices 42 are constructed in the above described manner and are mounted on opposite ends of a mobile lift machine vehicle 11. The motors 54 of these lift mechanisms are utilized to lower the fixtures 52 to the lowered positions, retracting and storing the support guides 48, 49 and the bands of the helical push actuators 64 as previously described above. The machine is moved into position beneath a vehicle body and the motors 54 are operated to extend the push actuator 64 to lift the fixture 52 and thus the chassis modules 20 to the raised position. At least one and preferably two vertical guides 48, 49 are provided between the vehicle and each upper base 53 to support the fixtures 52 during their vertical movement.

It will thus be apparent that there has been provided in accordance with the present invention a chassis/body marriage machine and method which achieves the aims and advantages specified herein. It will of course be understood that the foregoing description is of a preferred exemplary embodiment of the invention and that the invention is not limited to the specific embodiment shown. Various changes and modifications will become apparent to those skilled in the art and all such variations and modifications are intended to come within the scope of the appended claims.

As used in this specification and appended claims, the terms “for example,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that necessarily requires a different interpretation.

1. Apparatus for lifting and supporting an automotive chassis module in position to be assembled with an automotive body along a moving assembly line, said apparatus comprising:
a mobile vehicle;
at least one fixture arranged above said vehicle for receiving and supporting the chassis module; and
a guided lift mechanism for moving said fixture vertically between a lowered position and a raised position, said mechanism including a push actuator having a drive motor and at least one band that can be advanced and retracted in a vertical helix with an end of said band being coupled to said fixture to move said fixture between said lowered and said raised positions by helical advancement of said band under control of said motor, said lift mechanism further including at least one support member extending between said fixture and said vehicle operative to guide said fixture in the vertical direction and restrain said fixture from moving horizontally.

2. The apparatus of claim 1, wherein said vehicle comprises an automatic guided vehicle.

3. The apparatus of claim 1, wherein said vehicle comprises a tow-veyor.

4. The apparatus of claim 1, including a base removably mounted on said vehicle, and wherein said guided lift mechanism is mounted on said base.

5. The apparatus of claim 1, wherein said support member comprises at least a pair of vertically extendible guides spaced laterally from and extending parallel to said vertical helix of said push actuator.

6. The apparatus of claim 1, wherein said at least one support member comprises at least three vertically extendible guides spaced laterally from and extending parallel to said vertical helix.

7. The apparatus of claim 1, wherein said at least one support member comprises one or more telescoping guides.

8. The apparatus of claim 1, wherein there are a pair of said guided lift mechanisms supported on said vehicle in longitudinally spaced relation to one another.

9. The apparatus of claim 8, including a pair of bases detachably mounted on said vehicle in said longitudinally spaced relation and wherein said guided lift mechanisms are each mounted on a respective one of said bases so as to be readily mounted and dismounted from said vehicle.

10. The apparatus of claim 9, wherein said bases are located at a predetermined height on said vehicle and wherein said vehicle includes a longitudinal region provided between said bases.

11. The apparatus of claim 10, wherein said longitudinal region includes walk-through sections adjacent each of said bases having a height about the same or less than that of said bases.

12. The apparatus of claim 11, wherein said walk-through sections have a height about the same as that of said bases.

13. The apparatus of claim 8 wherein said vehicle has a longitudinally extending interference free region, said lift mechanisms being located within said interference free region.

14. The apparatus of claim 1, wherein said fixture is mounted on an upper base and wherein said push actuator said at least one support member are attached to a lower side of said upper base.

15. The apparatus of claim 14, wherein said fixture is attached to said upper base via a floating plate mechanism that permits horizontal adjustment of the position of said fixture relative to said upper base.

16. The apparatus of claim 1, wherein said at least one band comprises first and second continuous bands, said push actuator being operable to raise said platen by advancing said first and second bands upwardly in a helix with adjacent turns of said first band being spaced and individual turns of said second band being inserted between the spaced turns of said first band during upward advancement of said platen.

17. A method of supporting and lifting an automotive chassis module for assembly with an automotive body, said method comprising the steps of:
loading the chassis module onto a fixture supported at a lowered position and coupled to a push actuator mounted on a mobile vehicle;
operating the push actuator to raise the fixture vertically by upward advancement of at least one helical band; and
providing at least one support member between the fixture and the vehicle to guide the fixture during its vertical movement while restraining the fixture from horizontal movement.

18. The method of claim 17, including storing a retracted section of the band in a coiled condition beneath the fixture.

19. The method of claim 17, wherein said operating step further comprises raising the fixture by upward advancement of a pair of interleaved helical bands.

20. The method of claim 19, including storing a retracted section of a first one of said bands in a spiral coil beneath the fixture and storing a retracted section of the second of said bands in a helical stack beneath the fixture.
